(19) United States
(12) Patent Application Publication
(10) Pub. No.: US 2015/0091834 A1
(43) Pub. Date: Apr. 2, 2015

(54) DISPLAY SCREEN WITH DYNAMIC TACTILE PIXELS AND METHODS OF MANUFACTURE AND USE THEREOF

(71) Applicant: Thomas M. Johnson, Flowery Branch, GA (US)

(72) Inventor: Thomas M. Johnson, Flowery Branch, GA (US)

(21) Appl. No.: 14/502,121

(22) Filed: Sep. 30, 2014

Related U.S. Application Data
(60) Provisional application No. 61/960,969, filed on Oct. 2, 2013.

(51) Int. Cl. G06F 3/01; G06F 3/041

(52) U.S. Cl. CPC G06F 3/016; G06F 3/041; G06F 2203/04102
USPC 345/173

(57) ABSTRACT

A display screen with dynamic tactile pixels includes a flexible cover, and a plurality of cells. The plurality of cells are beneath the flexible cover. Each of the cells contain an expandable fluid that may expand upon activation. Whereby, the flexible cover will stretch and rise to include the tactile pixels when the cells beneath it are activated and raised.

### CROSS-REFERENCE TO RELATED APPLICATIONS

To the full extent permitted by law, the present U.S. Non-provisional patent application hereby claims priority to and the full benefit of U.S. Non-provisional application entitled “Dynamic Tactile Pixels,” having assigned Ser. No. 61/960,969, filed on Oct. 2, 2013, incorporated herein by reference in its entirety.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The instant disclosure is directed toward display screens for electronic, and more particularly, toward display screens with dynamic tactile pixels for desktops, laptops, tablets, e-readers and other like display devices.

2. Description of the Related Art

Electronic media is becoming ever increasingly popular with todays technology. Electronic media may include any media that use electronics or electromechanical energy for the end user (audience) to access the content. This is in contrast to static media (mainly print media), which today are most often created electronically, but do not require electronics to be accessed by the end user in the printed form. The primary electronic media sources familiar to the general public are video recordings, audio recordings, multimedia presentations, slide presentations, CD-ROM and online content. Most new media are in the form of digital media.

One problem with electronic media is that some electronic media is not adapted for use by blind users, which require the media to have audio or be put into braille or embossed tactile form. However, when audio is not practical or desired, blind users may especially require the electronic media in braille or embossed tactile form. In the face of audio screen-reader software, braille usage has declined. However, braille education remains important for developing reading skills among blind and visually impaired children, and braille literacy correlates with higher employment rates. Braille characters are small rectangular blocks called cells that contain tiny palpable bumps called raised dots. The number and arrangement of these dots distinguish one character from another. Braille cells are not the only thing to appear in embossed text. There may be embossed illustrations and graphs, with the lines either solid or made of series of dots, arrows, bullets that are larger than braille dots, etc. As such, there is clearly a need to provide electronic media in braille and other forms of embossed text.

In addition, for non-blind users, touch screen displays for electronic media are becoming more widely used on cell phones, tablets, laptops, desktops, the like, etc. However, one issue with touch screens is erroneous touches or misplaced fingers. This may be due to the users visual perception not aligning with their fingers. As such, a touch screen with some tactile feedback may be helpful in reducing or eliminating erroneous touches.

As a result, there is clearly an unmet need for providing a display screen for electronics with dynamic tactile pixels. The instant disclosure may be designed to address at least one or all of these problems.

### SUMMARY

Briefly described, in select embodiments, the present disclosure of display screens with dynamic tactile pixels may generally include a flexible cover, and a plurality of cells. The plurality of cells are beneath the flexible cover. Each of the cells may contain an expandable fluid that may expand upon activation. Whereby, the flexible cover may stretch and rise to include the tactile pixels when the cells beneath it are activated and raised.

In one embodiment, the cells may include a nonflexible container for housing the expandable fluid. In this embodiment, when the cells are activated and expand, the expandable fluid may expand the nonflexible container from an at rest level to an expanded level. The expanded level may be higher thereby creating the tactile pixel in the flexible cover.

In select embodiments, the expandable fluid may be expandable from a magnetic field or magnets. In these magnetic embodiments, the expandable fluid may be ferrofluid.

In other select embodiments, the expandable fluid may be expandable from a head source or head.

One feature may be the inclusion of a plurality of activation devices and a controller. In this embodiment, the activation devices may be associated with the plurality of cells, where each of the activation devices may be operable to activate the expandable fluid. The controller may be for controlling each of the activation devices.

In select embodiments, the controller may be a logic circuit or computer.

Another feature may be the inclusion of a plurality of conductors for connecting each of the activation devices with the controller.

In select embodiments, the activation devices may include a magnetic field or magnets.

In other select embodiments, the activation devices may include a heat source or heat.

Another feature may be that the display screen with dynamic tactile pixels may be included on a computer device, like a desktop, a laptop, a tablet, an e-reader, the like, etc.

Another feature of the display screen with dynamic tactile pixels may be that it can display braille, tactile feedback for touch screens, or combinations thereof.

The present disclosure also includes a method of displaying braille utilizing any of the embodiments of display screens with dynamic tactile pixels as shown and described herein. The method of displaying braille may generally include: a step of providing the display screen with dynamic tactile pixels in any of the embodiments as shown and described herein; and a step of activating the desired cells for creating the desired braille from the tactile pixels on the display screen.

In one embodiment of the method of displaying braille, when the display screen with tactile pixels includes the plurality of activation devices associated with the plurality of cells, each of the activation devices being operable to activate said expandable fluid, and a controller for controlling each of the activation devices, the step of activating the desired cells for creating the desired braille from the tactile pixels on the display screen may further include a step of controlling the desired activation devices to activate the expandable fluid in the desired cells via the controller.

One feature of the method of displaying braille may be that it can be carried out on a computer device like a desktop, a laptop, a tablet, an e-reader, or the like, etc.

The present disclosure also includes a method of providing tactile feedback utilizing any of the embodiments of display screens with dynamic tactile pixels as shown and described herein. The method of providing tactile feedback may generally include: a step of providing the display screen with dynamic tactile pixels in any of the embodiments as shown and described herein; and a step of activating the desired cells for creating the desired tactile feedback from the tactile pixels on the display screen.

In one embodiment of the method of providing tactile feedback, when the display screen with tactile pixels includes the plurality of activation devices associated with the plurality of cells, each of the activation devices being operable to activate said expandable fluid, and a controller for controlling each of the activation devices, the step of activating the desired cells for creating the desired tactile feedback from the tactile pixels on the display screen may further include a step of controlling the desired activation devices to activate the expandable fluid in the desired cells via the controller.

One feature of the method of providing tactile feedback may be that it can be carried out on a computer device like a desktop, a laptop, a tablet, an e-reader, or the like, etc.

These and other features of the display screens with dynamic tactile pixels will become more apparent to one skilled in the art from the prior Summary, and following Brief Description of the Drawings, Detailed Description, and Claims when read in light of the accompanying Detailed Drawings.

### BRIEF DESCRIPTION OF THE DRAWINGS

The present display screens with dynamic tactile pixels and methods of manufacture and use thereof will be better understood by reading the Detailed Description with reference to the accompanying drawings, which are not necessarily drawn to scale, and in which like reference numerals denote similar structure and refer to like elements throughout, and in which:

FIG. 1 is an environmental view of a display screen with dynamic tactile pixels on a tablet or e-reader according to select embodiments of the instant disclosure;

FIG. 2 is a perspective view of a display screen with dynamic tactile pixels according to select embodiments of the instant disclosure;

FIG. 3 is a cross-sectional side view of the display screen with dynamic tactile pixels of FIG. 2;

FIG. 4 is a flow chart of the method of displaying braille according to select embodiments of the instant disclosure;

FIG. 5 is a flow chart of the method of displaying tactile feedback according to select embodiments of the instant disclosure; and

FIG. 6 is a perspective view of a display screen with dynamic tactile pixels on a tablet or e-reader according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

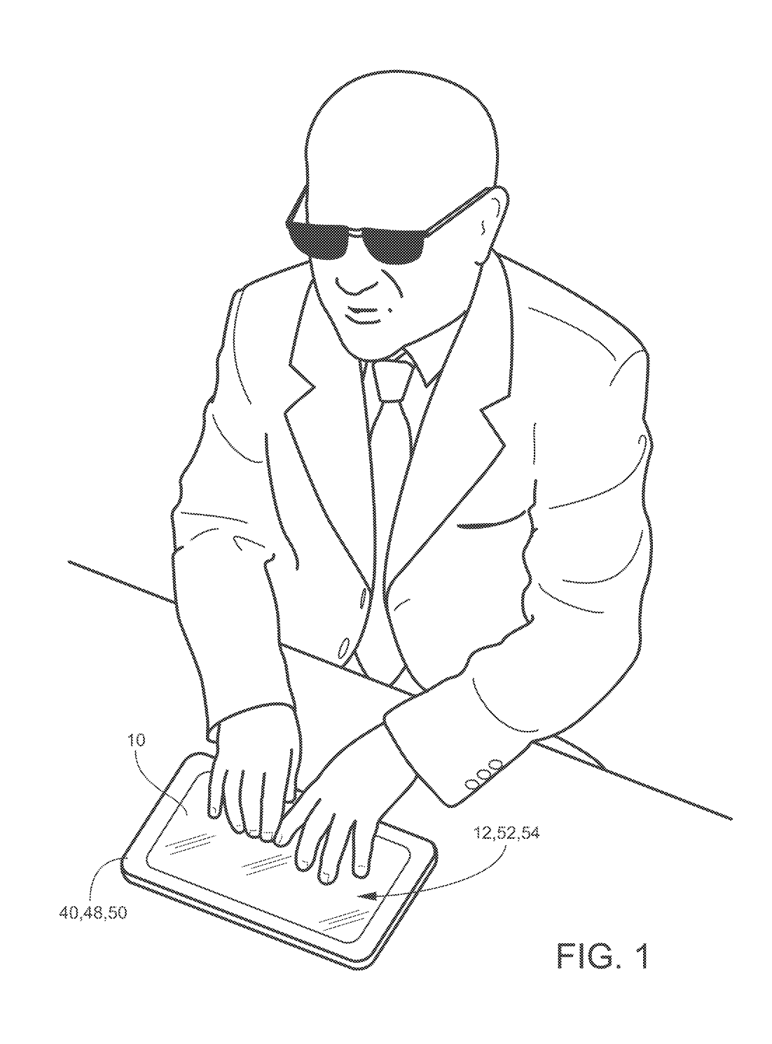

In describing the example embodiments of the present disclosure, as illustrated in FIGS. 1-6, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

The instant disclosure is directed toward display screens with dynamic tactile pixels and methods of manufacture and use thereof. Referring now to FIGS. 1-3 and 6 by way of example, and not limitation, therein is illustrated example embodiments of display screen 10 with dynamic tactile pixels 12. The instant disclosure may provide display screen 10 that can change its pixels dynamically to allow information to be displayed tactilely. As such, display screen 10 may be a display screen for computing devices that allows the information on the screen to be determined by touch. In select embodiments, text may be displayed as braille 52 or any other text display formats requiring or desiring tactile enhancement. In addition, touch can enhance other visual display items, like by providing tactile feedback 54 on touch screens. For example, an OK button on a touch screen may be enhanced by making it stick out in 3D, or pictures or other desired items and/or buttons may be given three dimensional effects.

Display screen 10 with dynamic tactile pixels 12 may generally include flexible cover 14 and plurality of cells 16. Cells 16 may be beneath flexible cover 14. Each of cells 16 may contain expandable fluid 18 that may expand upon activation. Whereby, flexible cover 14 may stretch and rise to include tactile pixels 12 when cells 16 beneath it are activated and raised.

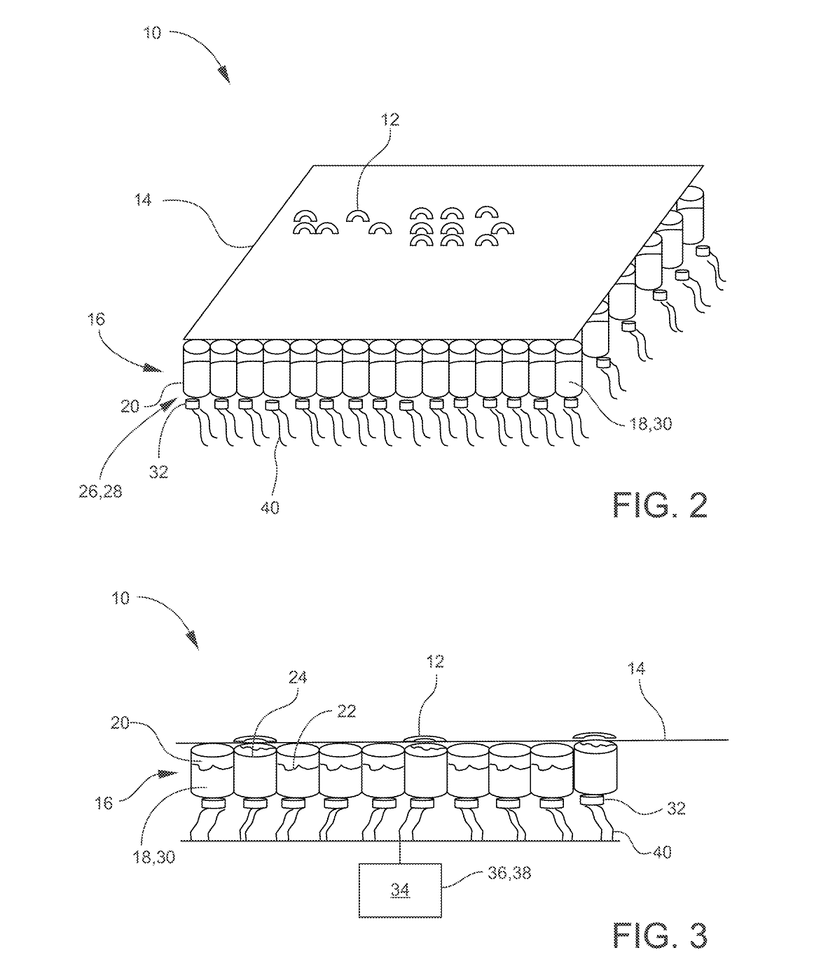

Flexible cover 14 may be included in display screen 10. See FIGS. 2-3. Flexible cover 14 may be for providing a flexible surface for dynamic tactile pixels to be generated on. Flexible cover 14 may be any flexible material or surface capable of providing a flexible surface for dynamic tactile pixels 12 to be generated on.

Cells 16 may be included in display screen 10. See FIGS. 2-3. Cells 16 may be for housing expandable fluid 18. Cells 16 may also allow expandable fluid 18 to expand and create dynamic tactile pixels 12 in flexible cover 14. Cells 16 may be any device or means capable of housing expandable fluid 18 that may allow expandable fluid 18 to expand and create dynamic tactile pixels 12 in flexible cover 14. Cells 16 may be provided in any desired size or shape for creating various size or shaped dynamic tactile pixels 12. In one embodiment, cells 16 may include nonflexible container 20. Nonflexible container 20 may be for housing expandable fluid 18. Nonflexible container 20 may allow cells 16 to be activated and expand, where expandable fluid 18 expands nonflexible container 20 from at rest level 22 to expanded level 24 (see FIG. 3). Expanded level 24 may be higher thereby creating tactile pixel 12 in flexible cover 14.

Expandable fluid 18 may be included in display screen with dynamic tactile pixels 12. See FIGS. 2-3. Expandable fluid 18 may be for providing an expandable material below flexible cover 14 for creating dynamic tactile pixels 12 in flexible cover 14 upon expansion. Expandable fluid 18 may be any expandable fluid, including, but not limited to, any expandable fluid, or any expandable gas. In addition, expandable fluid 18 may be expandable by any means or device or by any type of activation. In select embodiments, expandable fluid 18 may be expandable from magnetic field 26 (i.e. magnets). For example, in these magnetic embodiments, expandable fluid 18 may be ferrofluid 30. Ferrofluid 30 may be a liquid that becomes strongly magnetized in the presence of magnetic field 26. Ferrofluid 30 may be a colloidal liquid made of nanoscale ferromagnetic, or ferrimagnetic, particles suspended in a carrier fluid (usually an organic solvent or water). Each tiny particle is thoroughly coated with a surfactant to inhibit clumping. The magnetic attraction of nanoparticles may be weak enough that the surfactant's Van der Waals force may be sufficient to prevent magnetic clumping or agglomeration. Ferrofluid 30 may not retain magnetization in the absence of an externally applied field and thus may be classified as a superparamagnet. In other select embodiments, expandable fluid 18 may be expandable from heat source 28 (i.e. heat).

In select embodiments, display screen 10 with dynamic tactile pixels 12 may further include plurality of activation devices 32 controlled by controller 34. Each activation device 32 may be associated with one of cells 16, or a plurality of cells 16. Each activation device 32 may be operable to activate expandable fluid 18 inside cells 16. Controller 34 may be for controlling each of the activation devices 32. Controller 34 may be any device, means, or combination thereof for controlling each of the activation devices 32. For example, controller 34 may be logic circuit 36 or computer 38. Conductors 40 may also be included in these embodiments for connecting each of the activation devices 32 with controller 34. Activation devices 32 may be any device, means, or combination thereof, for activating expandable fluid 18 in cells 16. In select embodiments, activation devices 32 may include magnetic field 26 (i.e. magnets). In other select embodiments, activation devices 32 may include heat source (i.e. heat). Activation devices 32 may be designed for providing the proper activation means for the expandable fluid 18 used and the desired size and/or shape of dynamic tactile pixels 12.

Display screen 10 with dynamic tactile pixels 12 may be a display screen, touch screen, the like, etc. Display screen 10 may be included on computer device 42. Computer device 42 may include, but is clearly not limited thereto, a desktop, a laptop, tablet 48, or e-reader 50. In sum, display screen 10 with dynamic tactile pixels 12 may be included on any electronic device requiring and/or desiring a screen or display screen with tactile pixels.

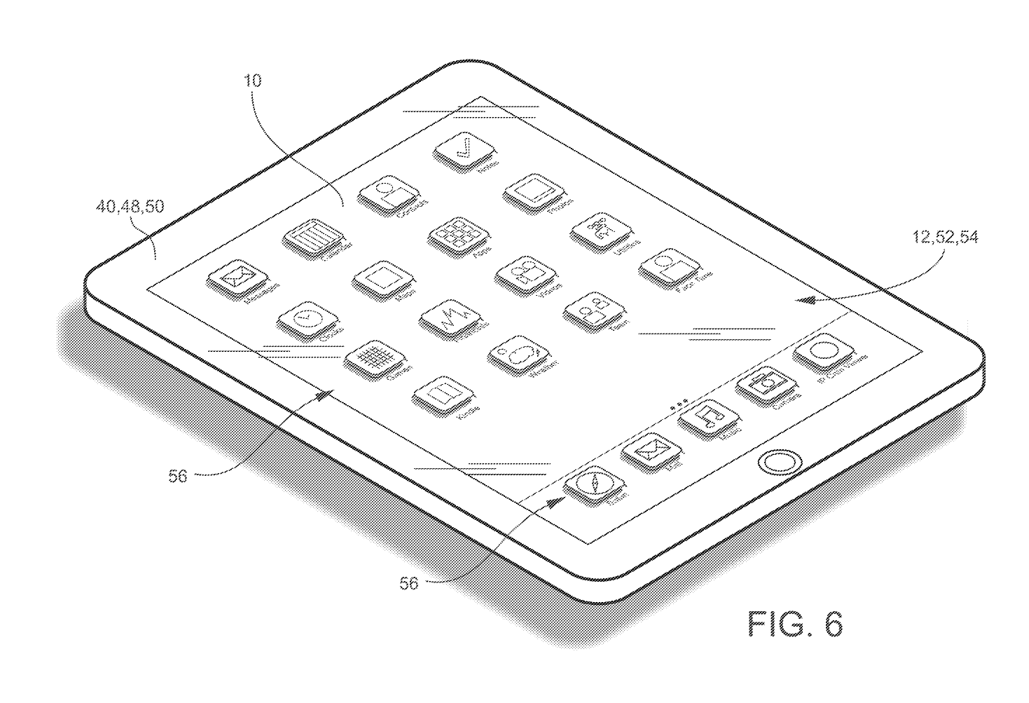

Display screen 10 with dynamic tactile pixels 12 may be for providing tactile pixels 12 on various electronic devices and may be capable of providing any various shapes or sizes of tactile pixels, including any shape, size or type of text, pictures, symbols, the like, etc. In select example embodiments, as shown in FIG. 1, display screen 10 may display braille 52. In other select example embodiments, see FIG. 6, display screen 10 may provide tactile feedback 54, like for touch screens. For example, in these embodiments, as shown in FIG. 6, display screen 10 may be provided on a tablet 48, like an Ipad®, e-reader 50, like a Kindle®, phone, laptop, or other similar touch screen devices, where tactile feedback 54 may be in the form of raised or 3D icons 56, touch screen buttons, home screen buttons, menu buttons, the like, or combinations thereof. In other select example embodiments, display screen 10 with dynamic tactile pixels 12 may display braille 52 and may provide tactile feedback 54, like for touch screens.

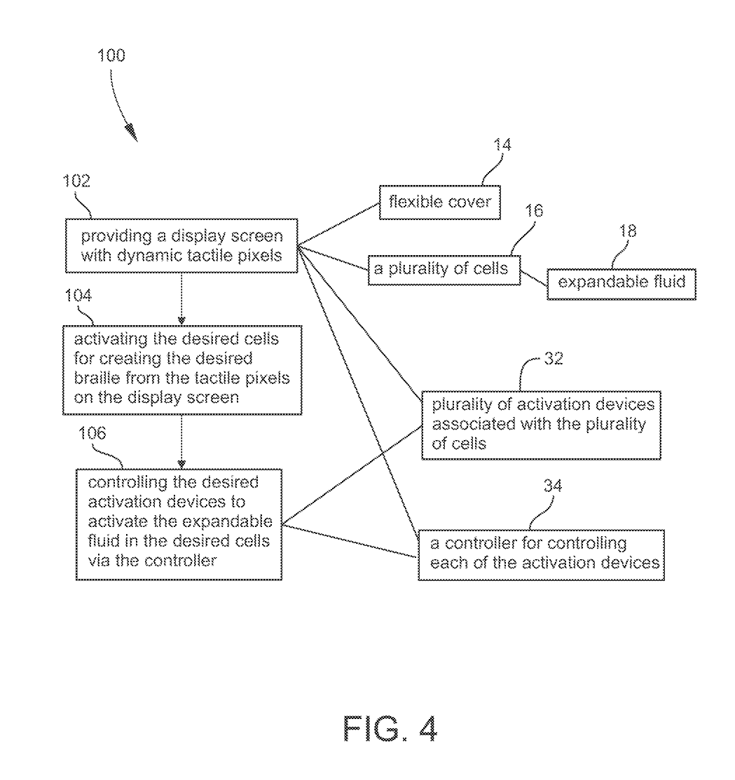

Referring now to FIG. 4, the present disclosure also includes method 100 of displaying braille 52 utilizing any of the embodiments of display screen 10 with dynamic tactile pixels 12 as shown and described herein. Method 100 of displaying braille 52 may generally include: step 102 of providing display screen 10 with dynamic tactile pixels 12 in any of the embodiments as shown and described herein; and step 104 of activating the desired cells 16 for creating the desired braille 52 from tactile pixels 12 on display screen 10.

In one embodiment of method 100 of displaying braille 52, when display screen 10 with tactile pixels 12 includes plurality of activation devices 32 associated with the plurality of cells 16, each of the activation devices 32 being operable to activate expandable fluid 18, and controller 34 for controlling each of the activation devices 32, step 104 of activating the desired cells 16 for creating the desired braille 52 from tactile pixels 12 on display screen 10 may further include step 106 of controlling the desired activation devices 32 to activate expandable fluid 18 in the desired cells 16 via controller 34.

One feature of method 100 of displaying braille 52 may be that it can be carried out on computer device 42, including any electronic or computer device, like a desktop, a laptop, tablet 48, e-reader 50, or the like, etc.

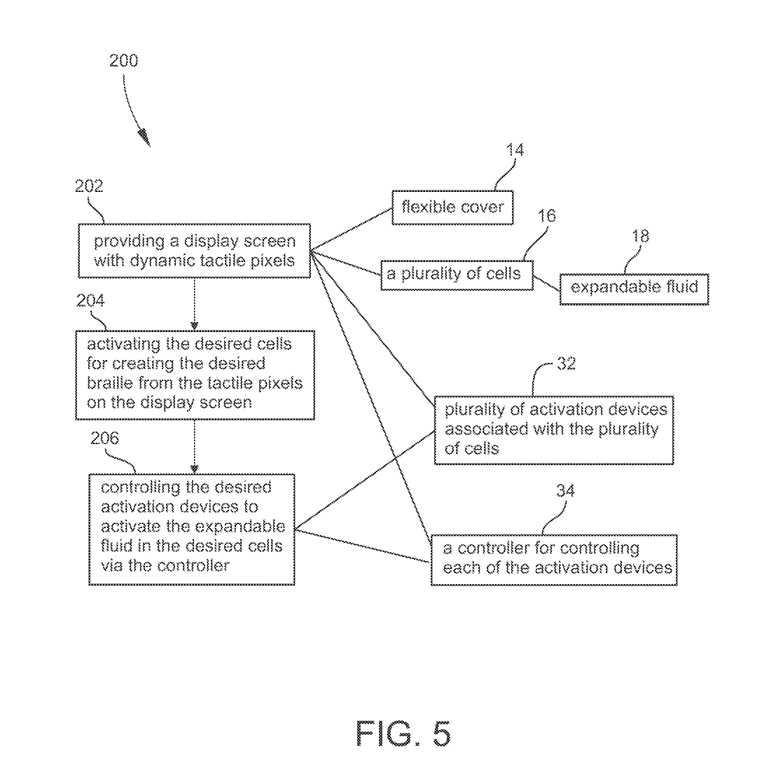

Referring now to FIG. 5, the present disclosure also includes method 200 of providing tactile feedback 54 utilizing any of the embodiments of display screen 10 with dynamic tactile pixels 12 as shown and described herein. Method 200 of providing tactile feedback 54 may generally include: step 202 of providing display screen 10 with dynamic tactile pixels 12 in any of the embodiments as shown and described herein; and step 204 of activating the desired cells 16 for creating the desired tactile feedback 54 from tactile pixels 12 on display screen 10.

In one embodiment of method 200 of providing tactile feedback 54, when display screen 10 with tactile pixels 12 includes plurality of activation devices 32 associated with the plurality of cells 16, each of the activation devices being operable to activate expandable fluid 18, and controller 34 for controlling each of the activation devices 32, step 204 of activating the desired cells 16 for creating the desired tactile feedback 54 from tactile pixels 12 on display screen 10 may further include step 206 of controlling the desired activation devices 32 to activate expandable fluid 18 in the desired cells 16 via controller 34.

One feature of method 200 of providing tactile feedback 54 may be that it can be carried out on computer device 42, including any electronic or computer device, like a desktop, a laptop, tablet 48, e-reader 50, or the like, etc.

The advantages of the present disclosure of display screens 10 with dynamic tactile pixels 12 and methods 100 and 200 may include, but are clearly not limited to, presenting text in braille format 52 on e-reader 50, tablet 48, computer screen or other display device. It may also be used to create “buttons” that can be felt on control screens with tactile feedback 54. As such, display screen 10 may be used in combination with current display screens to enhance their usability.

The foregoing description and drawings comprise illustrative embodiments. Having thus described example embodiments, it should be noted by those skilled in the art that the within disclosures are example only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

What is claimed is:

1. A display screen with dynamic tactile pixels comprising:
a flexible cover;
a plurality of cells beneath said flexible cover, each of said cells containing an expandable fluid that may expand upon activation;
whereby, said flexible cover will stretch and rise to include the tactile pixels when the cells beneath it are activated and raised.

2. The display screen with dynamic tactile pixels of claim 1 wherein said cells comprise a nonflexible container for housing said expandable fluid.

3. The display screen with dynamic tactile pixels of claim 2 wherein, when said cells are activated and expand, the expandable fluid expands said nonflexible container from an at rest level to an expanded level.

4. The display screen with dynamic tactile pixels of claim 3 wherein said expanded level being higher thereby creating said tactile pixel in said flexible cover.

5. The display screen with dynamic tactile pixels of claim 1 wherein said expandable fluid being expandable from a magnetic field or expandable from heat.

6. The display screen with dynamic tactile pixels of claim 5 wherein said expandable fluid being ferrofluid.

7. The display screen with dynamic tactile pixels of claim 1 further comprising:
a plurality of activation devices associated with said plurality of cells, each of said activation devices being operable to activate said expandable fluid; and
a controller for controlling each of said activation devices.

8. The display screen with dynamic tactile pixels of claim 7 wherein said controller being a logic circuit or computer.

9. The display screen with dynamic tactile pixels of claim 7 further comprising a plurality of conductors for connecting each of said activation devices with said controller.

10. The display screen with dynamic tactile pixels of claim 7 wherein said activation devices including a magnetic field.

11. The display screen with dynamic tactile pixels of claim 7 wherein said activation devices including a heat source.

12. The display screen with dynamic tactile pixels of claim 1 being included on a computer device.

13. The display screen with dynamic tactile pixels of claim 12 wherein said computer device being a desktop, a laptop, a tablet, or an e-reader.

14. The display screen with dynamic tactile pixels of claim 12 displaying braille, displaying tactile feedback for touch screens, or combinations thereof.

15. A method of displaying braille comprising:
providing a display screen with dynamic tactile pixels comprising:
a flexible cover;
a plurality of cells beneath said flexible cover, each of said cells containing an expandable fluid that may expand upon activation;
whereby, said flexible cover will stretch and rise to include the tactile pixels when the cells beneath it are activated and raised;
activating the desired cells for creating the desired braille from the tactile pixels on the display screen.

16. The method of displaying braille of claim 15 wherein said provided display screen with tactile pixels further comprising: a plurality of activation devices associated with said plurality of cells, each of said activation devices being operable to activate said expandable fluid; and a controller for controlling each of said activation devices;
wherein said step of activating the desired cells for creating the desired braille from the tactile pixels on the display screen further including:
controlling the desired activation devices to activate the expandable fluid in the desired cells via the controller.

17. The method of displaying braille of claim 15 being on a computer device being a desktop, a laptop, a tablet, or an e-reader.

18. A method of providing tactile feedback on a touch screen comprising:
providing a display screen with dynamic tactile pixels comprising:
a flexible cover;
a plurality of cells beneath said flexible cover, each of said cells containing an expandable fluid that may expand upon activation;
whereby, said flexible cover will stretch and rise to include the tactile pixels when the cells beneath it are activated and raised; and
activating the desired cells for creating the desired tactile feedback from the tactile pixels on the display screen.

19. The method of providing tactile feedback on a touch screen of claim 18 wherein said provided display screen with tactile pixels further comprising: a plurality of activation devices associated with said plurality of cells, each of said activation devices being operable to activate said expandable fluid; and a controller for controlling each of said activation devices;
wherein said step of activating the desired cells for creating the desired tactile feedback from the tactile pixels on the display screen further including:
controlling the desired activation devices to activate the expandable fluid in the desired cells via the controller.

20. The method of providing tactile feedback on a touch screen of claim 18 being on a computer device being a desktop, a laptop, a tablet, or an e-reader.
